(19) United States
(12) Patent Application Publication
(10) Pub. No.: US 2008/0149870 A1
(43) Pub. Date: Jun. 26, 2008

(54) Electronically Controllable Distributing Valve

(75) Inventors: Armin Braun, Buttenheim (DE); Gunther Swarat, Hochstadt (DE); Roland Krapp, Wattendorf (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/816,938

(22) PCT Filed: Nov. 15, 2005
(86) PCT No.: PCT/EP05/12181

§ 371 Date: Oct. 1, 2007

(30) Foreign Application Priority Data
Feb. 23, 2005 (DE) 10 2005 008 164.9

(51) Int. Cl. F16K 31/02

(52) U.S. Cl. 251/129.09

(57) ABSTRACT

A distributing valve, in particular a hydraulic 3/2 path distributing valve is provided, having an actuating unit (1) and a valve unit (2) interacting therewith, wherein the actuating unit (1) includes at least one coil (3) and a movable armature (4), the valve unit (2) includes a valve element interacting with the armature (4), controlling connections between the valve unit (2) channels for directing a pressure medium and is provided with sealing bodies (13, 15) corresponding to valve seats (8, 9) pressed against the valve unit (2) housing, and a valve body (11) interacting with the armature (4), guided in the valve unit (2) housing (tubular body (6)) of the valve unit (2) and is connect to the sealing bodies (13,15).

The invention relates to a distributing valve, in particular to a hydraulic 3/2-path distributing valve, comprising an actuating unit and a valve unit interacting with the actuating unit, wherein the actuating unit comprises at least one coil and a movable armature, the valve unit comprises a valve element interacting with the armature, controlling connections between the valve unit channels for running pressurized substances, and is provided with one or more sealing bodies corresponding to one or more valve seats pressed against the valve unit housing.

### BACKGROUND OF THE INVENTION

This type of distributing valve is known from DE 197 54 257 A1. In this distributing valve, a valve shaft is connected to the armature and interacts with the sealing body via a spring-loaded sliding part.

This distributing valve construction is difficult and expensive both in manufacture and in installation, so that a simplification would be advantageous.

DE 198 27 281 C1 describes a distributing valve in which the armature interacts with a plunger which has a matching shape to the sealing body.

Attached to this, the plunger has an extension which interacts with another sealing body which is ball-shaped.

This valve unit and valve element are also difficult to manufacture, since the opening movement of the ball, which is not connected to the extension, must be limited by an additional component. Moreover, use of a ball which cannot be guided radially or can only be guided insufficiently generally leads to a degradation in the dynamic pressure characteristic regarding a reduced speed in pressure changes or increased fluctuations in the speed of pressure changes when closing the ball.

### OBJECT OF THE INVENTION

It is therefore the object of the invention to simplify and make less expensive the valve unit of the distribution valve while retaining optimum hydraulic function.

### SUMMARY OF THE INVENTION

The object of the invention is met in that a valve body is provided which interacts with the armature, leads into the valve unit housing, and is connected to the sealing body or bodies. The result is a component which is simple to manufacture and optimum in function. At the same time, if required, a distribution valve can be provided which has only one sealing body with one or more valve seats, or multiple sealing bodies with multiple valve seats.

Advantageously, the valve body is constructed as a molded plastic part. It has projecting bars which are used to guide it into the housing. Such a valve body is guided in the housing very well, because the bars have a relatively large range of guidance and because the body is lightweight. As a molded plastic part, it is also simple to manufacture.

According to an advantageous embodiment, the valve body surrounds a plunger shaft which is located on the side of the valve body away from the armature and is attached to a sealing body. This sealing body can thereby be manufactured as a single part and can also have a central opening into which the plunger shaft can be inserted. Furthermore, this sealing body can be made of plastic.

A particularly advantageous mounting option results when the plunger shaft and one sealing body are connected together by ultrasound welding during mounting of the valve unit. Alternative connection possibilities are also glue, screw, press-on, or clip connections. It is preferred to shape the sealing body as a cone.

In an additional advantageous embodiment of the invention, it is provided that the housing of the valve unit is shaped as a pipe body and that the valve seat or one of the valve seats is manufactured as a single part with the pipe body.

It is also possible for the valve seat or one of the valve seats to be matched in shape with a pot-shaped component and that this pot-shaped component be inserted into the pipe body, preferably pressed in. The pipe body can hereby be advantageously implemented as a pipe and manufactured from a sheet metal part, preferably from a sheet steel part, whereby particularly the valve seat located in the end region of the pipe body is manufactured by forming, preferably by crimping. This embodiment provides an advantageous way to manufacture the housing of the valve unit.

### BRIEF DESCRIPTION OF THE DRAWINGS

For the further explanation of the invention, reference is made to the drawings, in which an embodiment of the invention is shown in simplified form. In the drawings:

FIG. 1 shows a lengthwise cross-sectional view through a hydraulic 3/2-path distribution valve and

FIG. 2 shows a cross-sectional view through a sealing body according to FIG. 1.

### DETAILED DESCRIPTION OF THE DRAWINGS

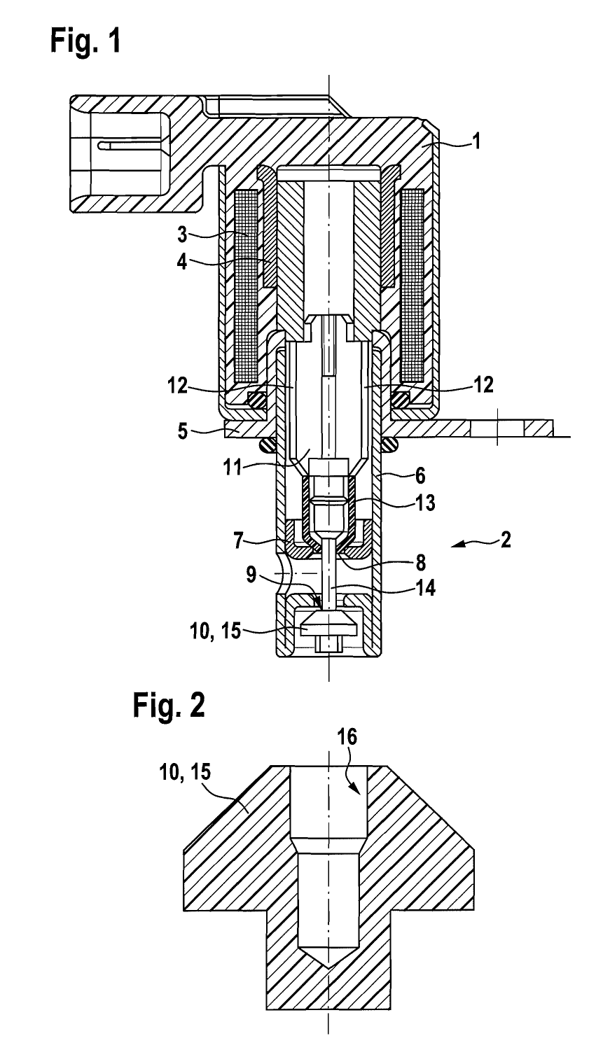

In FIGS. 1 and 2, insofar as details are shown, 1 denotes an actuator unit and 2 denotes a valve unit. Actuating unit 1 comprises, among other things, a spool 3 and an armature 4, which is among other things inserted into a magnetic core. The armature 4 furthermore has a stop, with which it can interact with the inner housing 5 of actuating unit 1. The inner housing 5 is partially formed as a magnetic core, since it interacts magnetically with spool 3. In the inner housing 5 there is a pipe body inserted which is denoted with 6, into which a pot-shaped component 7 is pressed, which has a valve seat 8. At a distance from valve seat 8, there is another valve seat 9 which is manufactured as a single part with pipe body 6. In pipe body 6, there is a valve body 11 inserted, which is implemented as a molded part, made of plastic, and has projecting edges 12 which interact with the inner wall of pipe body 6, resulting in very good guidance of valve body 11 in pipe body 6. The valve body 11 connects to armature 4 and is inserted with a space from the edges 12 into the pipe-shaped armature 4. Valve seat 8 interacts with a sealing body 13 which is shaped as a sleeve and is located on valve body 11. Valve body 11 furthermore surrounds a plunger shaft 14, which is connected to a sealing body 15. This interacts with valve seat 9.

In the embodiment, sealing body 15 is formed as a cone 10, which as shown in FIG. 2 has a central opening 16, with which cone 10 is centered when placed on plunger shaft 14. Cone 10 is fastened using ultrasound welding to plunger shaft 14. It is of particular significance that the ultrasound welding makes it possible to connect valve body 11 including plunger shaft 14 and sealing body 13 with cone 10 into pipe body 6 in the installed and attached state.

The formation and connection of valve body 11 and sealing body 15 shown in the embodiment is of course also advantageously usable in hydraulic distribution valves with only one sealing body interacting with two sealing seats.

### LIST OF REFERENCE NUMBERS

1 Actuating unit
2 Valve unit
3 Spool
4 Armature
5 Inner housing
6 Pipe body
7 Pot-shaped component
8 Valve seat
9 Valve seat
10 Cone
11 Valve body
12 Edges
13 Sealing body
14 Plunger shaft
15 Sealing body
16 Central opening

1. Distribution valve, particularly a hydraulic 3/2-path distribution valve, with an actuating unit and a valve unit interacting with the actuating unit, the actuating unit comprises at least one spool and a movable armature, and the valve unit includes a valve element which interacts with the armature, controls the connections between channels of the valve unit carrying a pressure medium, and has one or more sealing bodies which correspond to one or more valve seats pressed against a housing of valve unit, a valve body is provided which interacts with the armature, leads into the housing of the valve unit, and is connected to the one or more sealing bodies.

2. Distribution valve according to claim 1, wherein the valve body comprises a molded part, manufactured of plastic, and has projecting edges with which it is guided in the housing.

3. Distribution valve according to claim 1, wherein the valve body surrounds a plunger shaft which is located on a side of the valve body away from the armature and is connected to a sealing body.

4. Distribution valve according to claim 3, wherein the one sealing body is manufactured as a single part and has a central opening in which the plunger shaft can be inserted.

5. Distribution valve according to claim 4, wherein the one sealing body is made of plastic.

6. Distribution valve according to claim 1, wherein when mounting the valve unit, the plunger shaft and the one sealing body are connected together using ultrasound welding.

7. Distribution valve according to claim 6, wherein the one sealing body is formed as a cone.

8. Distribution valve according to claim 1, wherein the housing of the valve unit comprises a pipe body and one of the valve seats is manufactured in one piece with the pipe body.

9. Distribution valve according to claim 8, wherein one of the valve seats is shaped to match a pot-shaped component and that the pot-shaped component is inserted into the pipe body, preferably pressed in.

10. Distribution valve according to claim 1, wherein the pipe body is manufactured from a sheet metal part, preferably sheet steel, and at least one of the valve seats is made by forming, preferably crimping.
